(19) United States
(12) Patent Application Publication
(10) Pub. No.: US 2020/0265392 A1
(43) Pub. Date: Aug. 20, 2020

(54) PEER TO PEER PAYMENT AGGREGATION AND INTEGRATION APPLICATION

(71) Applicant: Peter Garrett, Aromas, CA (US)

(72) Inventor: Peter Garrett, Aromas, CA (US)

(21) Appl. No.: 16/282,036

(22) Filed: Feb. 21, 2019

Related U.S. Application Data
(60) Provisional application No. 62/633,522, filed on Feb. 21, 2018.

(51) Int. Cl. G06Q 20/10; G06Q 20/32; G06Q 20/38; G06Q 20/40

(52) U.S. Cl. CPC G06Q 20/10; G06Q 20/3278; G06Q 2220/00; G06Q 20/381; G06Q 20/40; G06Q 20/322

(57) ABSTRACT

This invention comprises a cloud based application programming interface facility wherein all domestic and foreign peer to peer payment systems are accessible with initial user info such as email address. This cloud based application programming interface facility allows users of disparate Peer to Peer payment systems be them domestic, International or Cryptocurrencies exchanges to exchange funds as easily as if they were using the same system.

### CROSS-REFERENCE TO RELATED DOCUMENTS

This US Non-Provisional patent application claims priority to earlier filed co-pending U.S. provisional patent application Ser. No. 62/633,522 filed on Feb. 21, 2018. The entire disclosure of said provisional application is included herein at least by reference

### BACKGROUND OF THE INVENTION

### Field of the Invention

The present invention is in the technical area of Fintech and more particularly to peer to peer payment systems.

### Discussion of the State of the Art

Peer to peer payment have become very popular among millennials. The young and old folks are learning that they can take a hold of their finances and become self bankers. Paying friends and family by phone or computer was first popularized by PayPal and has since been offered by Google, Venmo (which is owned by PayPal), Square and others. The service is increasingly available through banks and credit unions, too, and on social media networks like Facebook and Snapchat.

Say you're out to dinner with your cousin Charlie and want to split the check. Instead of fumbling around exchanging bills and coins, Charlie puts down his card and you take out your phone. You'll open your app of choice, pick Charlie from your list of contacts, tap out the amount you want to send and you're PIN, and viola, Charlie gets a notification saying the money's been sent. Once the money gets to Charlie, he can leave it in his P2P account so it's there when it's his turn to pay, or he can transfer it to his bank account.

The P2P service is sort of like a middleman: You link your bank account or a credit card to your P2P account and it expedites these sorts of transactions. Different services may have different architectures, steps or requirements, but that's the gist of it

Peer to peer payments are easy to use if both parties to a transaction are using the same peer to peer service. If both parties to a transaction are not using the same service then problems arise. There are many peer to peer money transaction services. Some are domestic and some are International

What is clearly needed is a platform that lets you consolidate peer to peer payment applications into one mobile application domestic and or International. This application has all of the necessary Application Programming Interfaces (hereafter APIs) which communicate to all peer to peer payment applications that have APIs enabling transactions from any per to peer service foreign or domestic.

### BRIEF SUMMARY OF THE INVENTION

A universal peer to peer payments system application is taught comprising a first mobile smart device with a universal peer to peer payments system application installed used by user 1 on his smart device and a second mobile smart device with a peer to peer payments system application installed used by user 2. Both uses have access to a central application program interface cloud service capable of communicating with a plurality of domestic and International peer to peer payments systems being used by a plurality of users. A central application program interface cloud service capable of communicating with a plurality of International peer to peer payments systems being used by a plurality of users. In one embodiment the same central application program interface cloud service as described above is capable of communicating with a plurality of cryptocurrency exchanges being used by a plurality of users.

In one embodiment a two users want to share a bill with each other. One user is using one peer to peer payment service wishes to transfer currency to one or more different users using disparate peer to peer payment systems wherein one user 1 may initiate a currency transfer to another user 2 using a disparate peer to peer payment system and wherein the payment utilizes the central application program interface cloud service capable of communicating with a plurality of peer to peer payments systems to lookup both user's initial credentials and display both user's credentials on their perspective mobile smart devices and further wherein each user finishes signing into their disparate peer to peer payment services to finish the initiated transaction.

In another embodiment user 1 is using a domestic Peer to Peer system and user 2 is using an International peer to peer payments system. Both users are running the application which has access to a central application program interface cloud service thereby making the transactions possible.

In one embodiment user 1 is using a domestic peer to peer payments system and user 2 is using a cryptocurrency payment system. Both users are running the application which has access to a central application program interface cloud service thereby making the transactions possible.

In one embodiment user 1's and user 2's batteries are now dead on their smart devices and a third user is introduced owing both other users a part of a bill wherein his smart device with the universal peer to peer payments system application installed and wherein user 3 is able to pay user 1 and 2 their portion of the bill through his smart device by searching for and entering their initial credentials for their choice of peer to peer payment services through which they wish to receive their payments and having them enter their secondary credentials thereby finishing the transaction as if they were all using their own smart devices.

### BRIEF DESCRIPTION OF THE SEVERAL VIEWS OF THE DRAWINGS

FIG. 1 is an illustration of an application platform that enables a user to manage peer to peer money transfer according to one embodiment of the present invention.

FIG. 2 is an illustration of an application platform that enables a user to manage peer to domestic and International peer to peer money transfer according to one embodiment of the present invention.

### DETAILED DESCRIPTION OF THE INVENTION

The following elements are contained in Figure one. They will be named here briefly so we meet the PTO requirements of the drawings and element numbers.

Element 100 is the Edge mobile payment application that's will be at the heart of the invention. Element 101 is the Venmo P2P payment service. This one of the many P2P payment services

Element 102 is the Square Cash P2P payment service. This one of the many P2P payment services

Element 104 is the Google Wallet, another of the P2P payment service

Element 105 is the Zelle P2P payment service. The service is different in that they went to the banks and made a play to them to offer this to their customers. This worked very well.

Element 106 is a smart device or smart phone that is equipped with an app of the type that can reach out over the internet, wifi or on the cellular networks.

Element 107 is the selection function of the Edge mobile app, here selecting square cash.

Element 108 is a crypto account payment service.

Element 109 are the old type regular walk in banks.

Element 110 is user 110. Element 111 is reserved.

Element 112 is a communication between Google Wallet and Edge mobile pay app.

Element 113 is a communication between Zelle and Edge Mobile pay app.

Element 114 is a communication between Crypto Exchange and Edge Mobile pay app.

Element 115 is a communication between Square Cash and Edge Mobile pay app. Element 116 is a communication between Venmo and the Edge Mobile pay app.

Element 117 is user 117. Element 118 signifies blue tooth wireless communications between the 2 smart phones 106 and 122.

Element 119 shows the edge mobile API app and how it communicates through its APIs with the rest of the elements named herein.

Element 120 is user 120. Element 121 indicates that the bubble named “Edge Mobile Pay API app” is running on smart phone 106.

Element 122 is a second smartphone of smart device.

Both Elements 200 are the same. One shows the edge mobile API app running on smart phone 211 and again circled in the drawing how it communicates through its APIs with the rest of the elements named herein.

Element 201 shows that crypto accounts and domestic P2P apps are in the cloud on the internet.

Element 202 shows a crypto currency exchange and signifies any and all crypto exchanges. This exchange all algorithms necessary to calculate the value of one virtual currency to another are resident here on the exchange.

Element 203 shows most banks are which use the Zelle application for enabling their customers to have mobile banking.

The element 204 shows the domestic account selection area of the edge mobile app where the user would choose a domestic P2P payment service.

Element 205 shows the International P2P payment apps in their cloud on the internet.

Element 206 shows communications between crypto account 212 and crypto exchange 202.

Element 207 shows communications channel through the internet from Zelle app to most banks.

Element 208 shows the communications channel between the Edge Mobile Pay API Application 200 and cloud 201 and 205 and their indicated P2P apps and crypto accounts 212.

Element 209 shows the communications channel between the Edge Mobile Pay API Application 200 and cloud 205 and their indicated International P2P apps 205.

Element 210 shows the International P2P account selection area of the edge mobile app.

Element 211 shows the smart device or smartphone on which the Edge Mobile Application is running on. Element 212 shows a user's crypto account.

Element 213 shows the P2P payment app Google Wallet. Element 214 is user 214, element 215 is user 215, element 216 is user 216.

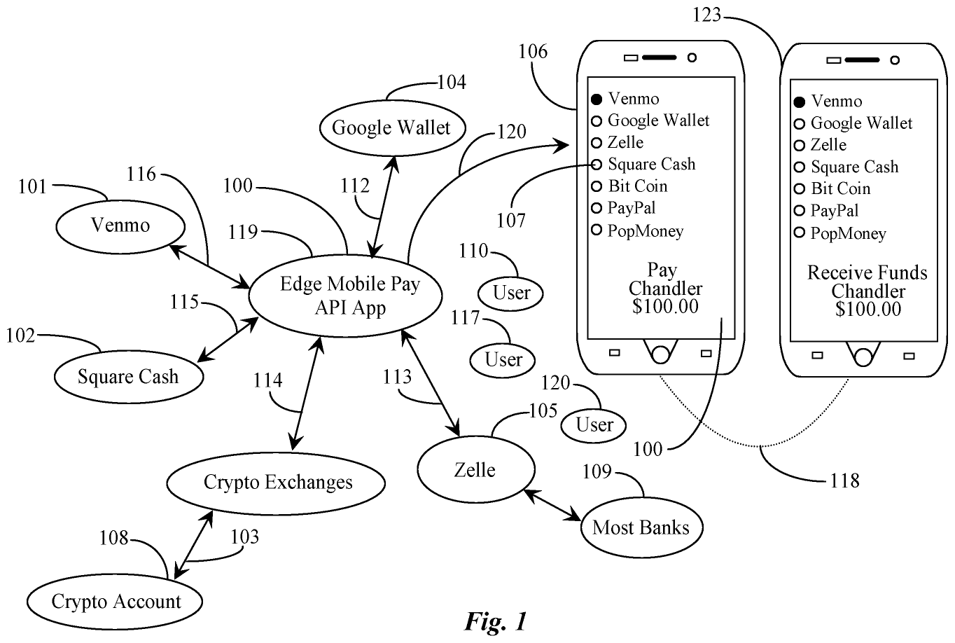

FIG. 1 is an illustration showing the functionality of a mobile peer to peer application running on a smart phone or smart device 106 according to one embodiment of the present invention. We will be speaking of mobile smart phone 106 in this embodiment. The app 119 however can run on any electronics device capable of running the application software.

In one embodiment we have 2 users that are out to dinner, User 110 and user 117. User 110 wishes to pay user 117 for his portion of the dinner bill. User 110 is using Venmo and user 117 is using square cash. Normally user 110 could not pay user 117 for his portion of the dinner because they are using different payment services which are not connected. The payment services they are using are competitors. With the Edge mobile application user 110 can pay user 117 for his portion of the dinner.

Mobile application 119 has APIs (application programming interfaces) for each payment service that operates in the US. This makes good business sense as all P2P services will get the transactions they are missing when both parties don't have the same P2P service.

Mobile app 119 uses API tool kits to speak and communicate and interface with all other P2P apps. Once User 110 registers in mobile app 119 mobile app 119 checks with all of the services through the APIs and finds all P2P services that user 110 has signed up for. App 119 lists those services and asks user 110 which of the apps he wants to use to pay user 117 for his portion of the dinner. User 110 chooses for instance Venmo. User then enters user 117's name, mobile number or email address in the mobile app 119 and finds all of the P2P services that user 117 has signed up for. User 117 may have another special username and pass or pin for their services. Whatever the identifier is for his account, it may be entered in mobile app 119 which brings up all apps user 117 is signed up to use. User 117 informs user 110 that he wants to use square cash. User 110 selects user 117's square cash account from the mobile app 119 for the destination of the money transfer. Mobile app 119 handles the rest of the transaction as it has APIs for both square cash and Venmo. Square Cash and Venmo now have a transaction that never would have happened otherwise.

In one embodiment let's say that completely different user 120 shows up and has dinner too. He needs to pay his part too since user 110 has paid the full amount of the dinner.

User 110's mobile app 119 will still process the transaction. Now user 120 wants to pay user 117 his portion of the bill. Users 117 and 120 both left their phones in the car charging. User 110's app 119 will still be able to process the transaction. Mobile app 119 does not care who is making the transactions as long as they both have signed up for peer to peer services and application 119 can find the accounts through its APIs associated with user 110 and user 120. User 110 selects the P2P app the payer 120 wants to use and the app that user 117 wants to use to receive user 120's portion of the dinner. User 110 asks users 117 and 120 which P2P services they want to use for the transaction. User 117 wants square cash and user 120 wants to use his Google wallet account. User 110 selects Google wallet for the payer 102 and square cash for user 117 as the payee. User 117 and user 120 enter their credentials (emails most likely) for their accounts in the app resident on user's phone. User 110 enters the amount of the transaction and selects “process transaction”. Because mobile app 119 has the APIs for both Google wallet and square cash the transaction is completed and dinner is paid for.

In another embodiment user 117 wants to pay user 110 for dinner with his crypto currency Bitcoin. Element number 121 shows in FIG. 1 that Edge Mobile API app is actually running on smart phone or device 106. All P2P apps and crypto currency exchanges and crypto accounts are in the cloud i.e. on the internet. Application 119 also has APIs for all of the major crypto currency exchanges so that a user can pay another user in crypto currency or US dollars. In this embodiment user 117 simply selects his crypto currency exchange in the mobile app. The APIs allow user 117 to enter his credentials into the mobile app and bring up his choices of crypto currency he wants to use. User 117 decides he wants to pay user 110 with his Bitcoin in choice section area 107. User selects his Google wallet to receive the payment from user 117. Now that the payments source and the receiving source have been selected in app 119 the transaction may now be completed by selecting an indicia in app 119 that initiates transaction and completes the transaction.

Users of Banks can seldom easily send funds from their bank to another bank without writing a check. Zelle pay 113 is mainly a bank to bank app that attempts to solve that problem. Zelle signs up banks to use their app and makes it available to their customers so they can send money to folks with different banks. Zelle currently has some 70 banks signed up. Most of the big banks are signed up with Zelle. Both banks must be using Zelle 105 for this to work.

In one preferred embodiment Edge Mobile Pay API application 119 has APIs and or API tool kits that allow Edge Mobile Pay API application 119 to interface with Zelle Pay and its customers. This opens up new possibilities for these customers. Now they can send funds to anyone from any bank to anyone from another bank with ease. These users can also send funds from Zelle to any of the P2P apps as well. They can even make deposits into their crypto currency accounts from Zelle or any of the other P2P accounts as well. What we strive for in this Edge Mobile application is simply self banking.

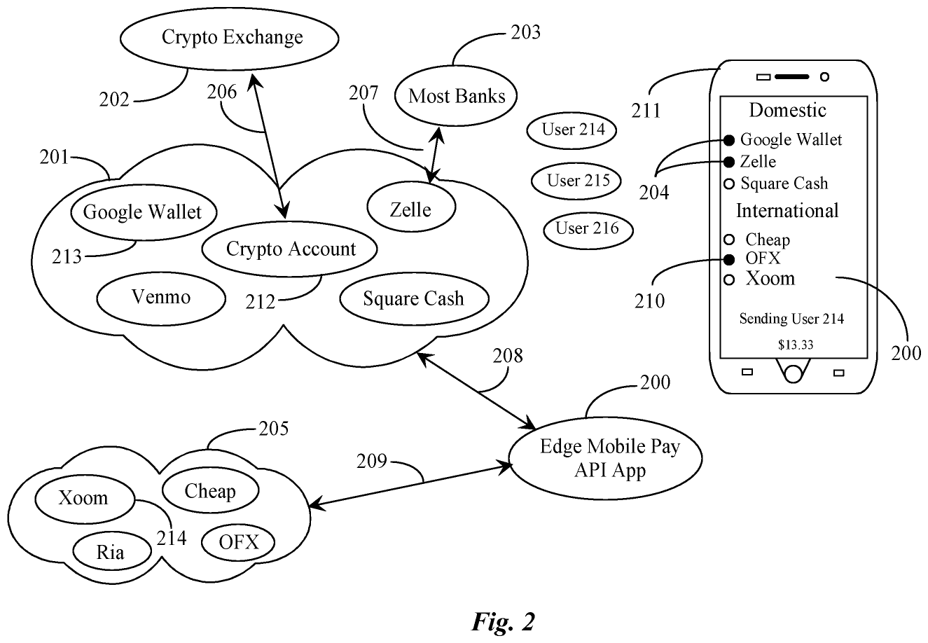

FIG. 2 is an illustration showing the functionality of a mobile Domestic and International peer to peer app consolidation application running on a smart phone or smart device 211 according to one embodiment of the present invention. We will be speaking of mobile smart phone 211 running consolidation app 200 in this embodiment. App 200 however can run on any electronics device capable of running the application software. Mobile application 200 has all necessary APIs to make transactions from any peep to peer app foreign and or domestic. A user can now make P2P payments to just about anyone regardless of which P2P app they are running foreign or domestic.

We have users 214, 215 and 216 out for drinks. User 215 is from Vanuatu and only has OFX as a P2P app. Users 214 and 216 don't have this app as it is an International app. Folks in the US usually have no need for an International P2P app. User 214 spends 39.99 for their drinks so he wants them each to pay him back 13.33 for their portion of the festivities. Edge Mobile Pay API Application 200 (hereafter for convenience “Mobile App 200”) has APIs for all of the P2P apps and other entities shown in FIG. 2. In this embodiment user 214 is running Mobile app 200 on his phone 211. He calls up his app on phone 211 and chooses to receive money. User 215 enters his credentials from his OFX app 210 and chooses to send 13.33 to user 214's Google wallet. Mobile app communicates through channel 209 to the international P2P network and finds the account for user 215 at OFX through its API for OFX. User 215 enters credentials and selects to send 13.33 to user 214. User 215 selects process and the transaction is completed. User 216 has his own phone 211 and calls his Mobile app 200 up on his phone and selects to send 13.33 to user 214 from his Zelle account which is connected to his bank account through link 207. User enters his credentials for Zelle in his Mobile app 200 which now communicates through channel 208 to the domestic P2P network and finds the account for user 216 at Zelle through its API for Zelle. User 215 enters credentials and selects to send 13.33 to user 214s Google wallet. User 216 selects process and that transaction is complete and user 214 has now been paid 13.33 from both user 215 and user 216 into his Google Wallet.

What is claimed is:

1. A universal peer to peer payments system application comprising:
a first mobile smart device with a peer to peer payments system application installed used by user 1;
a second mobile smart device with a peer to peer payments system application installed used by user 2;
a central application program interface cloud service capable of communicating with a plurality of domestic peer to peer payments systems being used by a plurality of users;
a central application program interface cloud service capable of communicating with a plurality of International peer to peer payments systems being used by a plurality of users;
the same central application program interface cloud service as described above capable of communicating with a plurality of cryptocurrency exchanges being used by a plurality of users;
a plurality of users of the above system wherein one user using one peer to peer payment service wishes to transfer currency to one or more different users using disparate peer to peer payment systems wherein one user 1 may initiate a currency transfer to another user 2 using a disparate peer to peer payment system and wherein the payment utilizes the central application program interface cloud service capable of communicating with a plurality of peer to peer payments systems to lookup both user's initial credentials and display both user's credentials on their perspective mobile smart devices and further wherein each user finishes signing into their disparate peer to peer payment services and finish the initiated transaction.

2. The system of claim 1 wherein user 1 is using a domestic Peer to Peer system and user 2 is using an International peer to peer payments system.

3. The system of claim 1 wherein user 1 is using a domestic peer to peer payments system and user 2 is using a cryptocurrency payment system.

4. The system of claim 1 wherein user 1's and user 2's batteries are now dead on their smart devices and a third user is introduced owing both other users a part of a bill wherein his smart device with the universal peer to peer payments system application installed and wherein user 3 is able to pay user 1 and 2 their portion of the bill through his smart device by searching for and entering their initial credentials for their choice of peer to peer payment services through which they wish to receive their payments and having them enter their secondary credentials thereby finishing the transaction as if they were all using their own smart devices.

5.
